(19) United States
(12) Patent Application Publication
(10) Pub. No.: US 2025/0182276 A1
(43) Pub. Date: Jun. 5, 2025

(54) IDENTIFYING LARGER OBJECTS IN EAR CONTENT SAMPLES

(71) Applicant: IDEXX Laboratories, Inc., Westbrook, ME (US)

(72) Inventors: Jason J. Aguiar, Freeport, ME (US); Jeremy Hammond, Standish, ME (US); James W. Russell, North Yarmouth, ME (US); David Steines, Scarborough, ME (US); Jason Karp, Portland, ME (US)

(21) Appl. No.: 18/961,614

(22) Filed: Nov. 27, 2024

Related U.S. Application Data
(60) Provisional application No. 63/604,597, filed on Nov. 30, 2023.

(51) Int. Cl. G06T 7/00

(52) U.S. Cl. CPC G06T 7/0012; G06T 2207/10056; G06T 2207/30024

(57) ABSTRACT

An apparatus includes: a sample chamber having at least one depth dimension configured to allow an object of interest to move, where the object of interest has a size of at least 100 micrometers; an imaging device configured to capture images of the sample chamber, where the imaging device includes a single objective lens and has a resolving power of approximately 25 micrometers or larger than 25 micrometers; at least one processor; and at least one memory storing instructions. The instructions, when executed, cause the apparatus to: access at least one image, captured by the imaging device, of at least a portion of the sample chamber; processing the at least one image to provide an indication of one of: an object of interest, no object of interest, or a location in the sample chamber of a potential object of interest; and providing an output based on the indication.

### CROSS-REFERENCE TO RELATED APPLICATIONS

This application claims the benefit of, and priority to, U.S. Provisional Patent Application No. 63/604,597, filed on Nov. 30, 2023, the entire contents of which are hereby incorporated herein by reference.

### TECHNICAL FIELD

The present disclosure relates to imaging ear content samples, and more particularly, to identifying larger objects in an ear content sample.

### BACKGROUND

Manual microscopy is an approach for analyzing blood cells and other biological samples. Using manual microscopy, a viewer can manually adjust the degree of magnification and can manually move a slide to view different portions of the slide.

### SUMMARY

In accordance with aspects of the present disclosure, an apparatus for detecting objects in a biological sample includes: a sample chamber having at least one depth dimension configured to allow an object of interest to move in the sample chamber, where the sample chamber is configured to contain a biological sample and the object of interest has a size of at least 100 micrometers; an imaging device configured to capture images of the sample chamber, where the imaging device includes a single objective lens and has a resolving power of approximately 25 micrometers or larger than 25 micrometers; at least one processor; and at least one memory storing instructions. The instructions, when executed by the at least one processor, cause the apparatus at least to perform, without human intervention: accessing at least one image, captured by the imaging device, of at least a portion of the sample chamber while the sample chamber contains the biological sample; processing the at least one image of at least the portion of the sample chamber to provide an indication of one of: an object of interest in the sample chamber, no object of interest in the sample chamber, or a location in the sample chamber of a potential object of interest; and providing an output based on the indication.

In accordance with aspects of the present disclosure, a method for detecting objects in a biological sample includes, without human intervention: accessing at least one image, captured by an imaging device, of at least a portion of a sample chamber while the sample chamber contains a biological sample, wherein: the sample chamber has at least one depth dimension configured to allow an object of interest to move in the sample chamber and the object of interest has a size of at least 100 micrometers, and the imaging device is configured to capture images of the sample chamber, where the imaging device includes a single objective lens and has a resolving power of approximately 25 micrometers or larger than 25 micrometers; processing the at least one image of at least the portion of the sample chamber to provide an indication of one of: an object of interest in the sample chamber, no object of interest in the sample chamber, or a location in the sample chamber of a potential object of interest; and providing an output based on the indication.

In accordance with aspects of the present disclosure, a processor-readable medium stores instructions which, when executed by at least one processor of an apparatus, causes the apparatus at least to perform, without human intervention: accessing at least one image, captured by an imaging device, of at least a portion of a sample chamber while the sample chamber contains a biological sample, wherein: the sample chamber has at least one depth dimension configured to allow an object of interest to move in the sample chamber and the object of interest has a size of at least 100 micrometers, and the imaging device is configured to capture images of the sample chamber, where the imaging device includes a single objective lens and has a resolving power of approximately 25 micrometers or larger than 25 micrometers; processing the at least one image of at least the portion of the sample chamber to provide an indication of one of: an object of interest in the sample chamber, no object of interest in the sample chamber, or a location in the sample chamber of a potential object of interest; and providing an output based on the indication.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of example components of an apparatus or system, in accordance with aspects of the present disclosure;

FIG. 2 is an example of an image of a portion of a sample chamber, in accordance with aspects of the present disclosure;

FIG. 3 is an example of a higher magnification image of a portion of a sample chamber, in accordance with aspects of the present disclosure;

FIG. 4 is a diagram of an example of imaging components, in accordance with aspects of the present disclosure;

FIG. 5 is a diagram of an example of a sample chamber, in accordance with aspects of the present disclosure;

FIG. 6 is a diagram of an example of a sample chamber, in accordance with aspects of the present disclosure;

FIG. 7 is a flow diagram of an example of a detection operation, in accordance with aspects of the present disclosure; and

FIG. 8 is a diagram of an example of components of a point-of-care apparatus, in accordance with aspects of the present disclosure.

### DETAILED DESCRIPTION

The present disclosure relates to identifying larger objects in an ear content sample contained in a sample chamber. In aspects, the present disclosure relates to identifying objects that are 100-micrometers or larger. In aspects, the present disclosure relates to imaging larger objects in a biological sample using an imaging device having a resolving power of 25-micrometers or a resolving power of larger than 25-micrometers. In aspects, an imaging device is capable of capturing images across an entire cross-sectional area of a sample chamber within a predetermined time duration, such as in less than ten minutes, less than eight minutes, or less than five minutes.

As used herein, the term “exemplary” does not necessarily mean “preferred” and may simply refer to an example unless the context clearly indicates otherwise. Although the disclosure is not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like.

As used herein, the term “approximately,” when applied to a value, means that the exact value may not be achieved due to factors such as, for example, manufacturing imperfections and/or wear over time, among other factors.

As used herein, the term “imaging device” refers to and means any device that is configured to sense at least the visible light spectrum and to provide an image. An imaging device may include components such as, without limitation, one or more lenses and a sensor.

As used herein, the term “field of view” refers to and means a region that is capturable by an imaging device. The term “working distance” refers to and means the object to lens distance where the image is at its sharpest focus. An image can be said to be focused on a scene at the working distance. The term “depth of field” refers to and means the distance between the nearest and furthest elements in a captured image that appear to be acceptably in focus. Depth of field and what is considered “acceptable” focus will be understood in the field of optical imaging. The term “resolving power” refers to the smallest distance between two features that an imaging device can clearly present as being separate features.

As used herein, the term “dilution ratio” refers to and means a ratio of volume of diluent to volume of biological sample. Accordingly, a ratio of volume of diluent to volume of biological sample of 75:1 may be described as a dilution ratio of 75:1. A diluent may be and include any substance or combination of substances that can be combined with a biological sample, including, without limitation, reagents, stains, buffers, and/or working fluids, among other possible substances.

Ear mites and bacterial ear infections are problems that manifest in felines, canines, and other animals. Certain constituents in an ear content sample include red blood cells, white blood cells, yeast, and bacteria. These constituents are, individually, generally less than 10-micrometers in size. Ear mites, on the other hand, are relatively large (for example, 200-800 microns) and include distinctive features that may not require sophisticated staining and imaging to identify, e.g., legs, hairs, heads, etc. The same may also apply to other relatively large objects in ear content samples, such as cell clusters, crystalline structures, pollen, dirt, and/or bacteria colonies, among others.

The present disclosure relates to identifying larger objects in ear content samples that are 100-micrometers or larger. In aspects, the present disclosure relates to imaging larger objects in a biological sample using an imaging device having a resolving power of 25-micrometers or a resolving power of larger than 25-micrometers. A 25-micrometer resolving power is a relatively weak resolving power. For example, optical microscopes in laboratories typically have resolving powers of around 0.2 micrometers. However, as explained below, using a 25-micrometer resolving power (or larger than 25-micrometer resolving power) is unexpectedly effective.

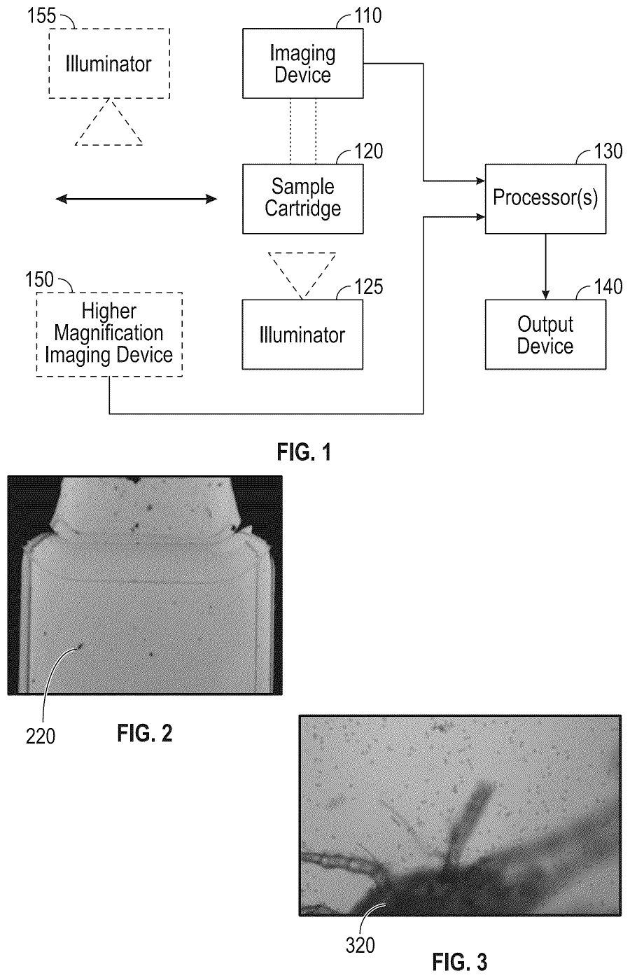

Referring to FIG. 1, a block diagram of various components is shown. The components include an imaging device 110, a sample cartridge 120, an illuminator 125, one or more processor(s) 130, and an output device 140. The components optionally include a higher magnification imaging device 150 and a second illuminator 155. In embodiments, the components 110-155 may be co-located in a single apparatus, such as in a point-of-care apparatus of a veterinary clinic. In embodiments, one or more of the components may be located in different systems or devices. For example, one or more of the processor(s) 130 may be a processor in a cloud system. In embodiments, the components may include a communication device (not shown) for communicating information between different systems or devices.

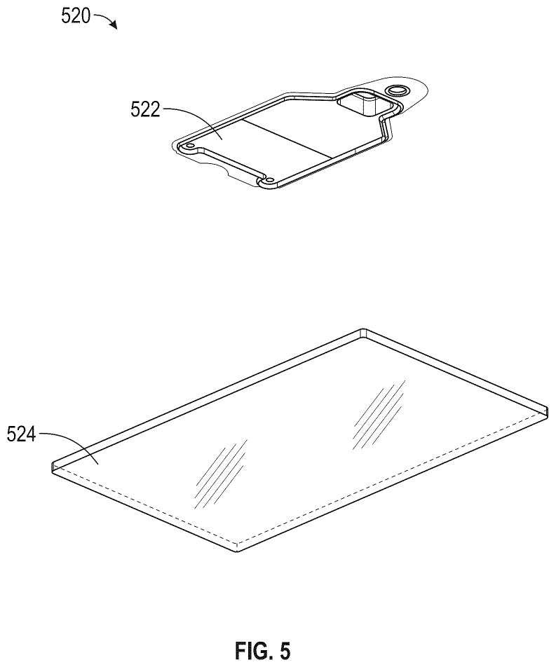

The imaging device 110 is configured to capture a field of view containing at least a portion of the sample cartridge 120. In particular, the sample cartridge 120 includes a sample chamber, and the imaging device 110 captures a field of view containing at least a portion of the sample chamber. An example of the sample cartridge 120 will be described in more detail in connection with FIG. 5. The sample chamber is illuminated by the illuminator 125, which may be a brightfield illuminator.

In embodiments, the sample cartridge 120 is movable to enable the imaging device 110 to capture different fields of view that contain different portions of the sample chamber. In embodiments, rather than the sample cartridge 120 moving, the imaging device 110 is movable to capture different fields of view of different portions of the sample chamber. In embodiments that include the higher magnification imaging device 150, the sample cartridge 120 may be movable to be illuminated by the second illuminator 155 and be imaged by the higher magnification imaging device 150. In embodiments, one or more of the imaging device 110, the illuminator 125, the higher magnification imaging device 150, and the second illuminator 155 are movable.

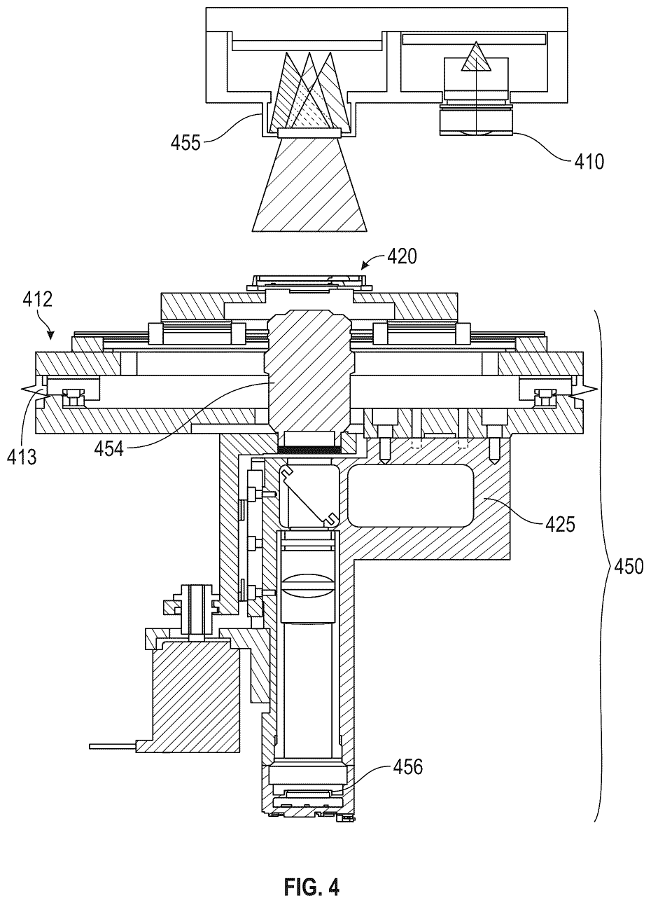

In embodiments, the imaging device 110, the illuminator 125, the higher magnification imaging device 150, and/or the second illuminator 155 may be combined or separated in various ways and may be positioned relative to the sample cartridge 120 in various ways. An example is shown in FIG. 4 and will be described below in connection with FIG. 4.

In embodiments, the imaging device 110 has relatively weak resolving power, such as a resolving power of 25-micrometers. Thus, the imaging device 110 will be able to clearly present features that are at least 25-micrometers apart as separate features, but features that are less than 25-micrometers apart will not present clearly as separate features and will appear blurred. In embodiments, the imaging device 110 has a resolving power of larger than 25-micrometers, such as a 100-micrometer resolving power, among other possibilities.

Capturing multiple fields of view will be described in more detail later herein. For now, it is sufficient to note that each field of view captures at least a portion of the sample chamber of the sample cartridge 120. In embodiments, for the imaging device 110, the imaging device 110 has a fixed optical magnification such that an entire cross-sectional area of a sample chamber of the sample cartridge 120 corresponds to less than ten fields of view, including as low as one, two, or four fields of view. In embodiments, for the higher magnification imaging device 150, the higher magnification imaging device 150 has a fixed optical magnification such that an entire cross-sectional area of a sample chamber of the sample cartridge 120 corresponds to more than one-hundred fields of view, such as in the range of two-hundred to four-hundred fields of view, among other possibilities. In embodiments, the imaging device 110 or the higher magnification imaging device 150 and/or the sample cartridge 120 move at a rate such that between fifty to one-hundred different fields of view are captured each minute. In embodiments, other rates of capturing fields of view are within the scope of the present disclosure.

With continuing reference to FIG. 1, the processor(s) 130 are configured to analyze the images captured by the imaging device 110. As an example, in embodiments where the imaging device 110 captures an image, the field of view is relatively large and the objects of interest (e.g., 100-micrometers or larger objects) will occupy a small area in the image. FIG. 2 shows an example of such an image. In the image of FIG. 2, a mite 220 is generally about 200-800 micrometers but still occupies a small area in the captured image. In embodiments such as FIG. 2, the processor(s) 130 may identify objects of interest in the images by their shape. Various ways of doing so include, without limitation, applying one or more trained machine learning models (e.g., convolutional neural network) that are trained to perform object detection to detect the objects of interest that are at least 100-micrometers in size, e.g., mites, cell clusters, bacteria colonies, etc.

As another example, and referring again to FIG. 1, in embodiments where the higher magnification imaging device 150 captures an image, the field of view is relatively small and the objects of interest (e.g., 100-micrometers or larger objects) will occupy a large area in the image. FIG. 3 shows an example of such an image, which shows the same mite 220 of FIG. 2 at higher magnification and captures just a portion of the mite. In embodiments such as FIG. 3, the processor(s) 130 may identify objects of interest in the images by their shape. Various ways of doing so include, without limitation, applying one or more trained machine learning models (e.g., convolutional neural network) that are trained to perform object detection to detect objects of interest that are at least 100-micrometers in size, e.g., mites, cell clusters, bacteria colonies, etc.

The examples of FIG. 2 and FIG. 3 are merely illustrative. In embodiments, other objects of interest (e.g., bacteria colonies, cell clusters, crystalline structures, etc.) may be imaged, and machine learning models and/or image analytics may be applied to detect one or more objects of interest in such images. In embodiments, and with reference to FIG. 1, the processor(s) 130 count number of objects of interest in the images.

The processor(s) 130 causes the output device 140 to provide information regarding objects of interest to a person or user, such as presence or absence of an object of interest (e.g., mites), among other possible information. The output device 140 may be any output device capable of communicating information to a person or user. In embodiments, the output device 140 is a display panel of a point-of-care device and is in the same device as the other components 110-130. In embodiments, the output device 140 may be an office computer or smartphone of a clinician, and a network device (not shown) may communicate the information to the office computer or smartphone for display. For example, the processor(s) 130 may cause a text message or an email, which contains the information, to be sent, and the output device 140 may receive and display the text message or email to a user. Other types of output devices 140 are contemplated to be within the scope of the present disclosure, such as audio output devices, among other possibilities.

FIG. 1 is merely an example of some components of an apparatus. It should be understood that an apparatus will include other components not shown in FIG. 1, such as a power supply, memory, electronic storage, network device, and/or other components. Such components, and other variations of an apparatus, are contemplated to be within the scope of the present disclosure.

Referring now to FIG. 4, there is shown an example of an imaging device 410, a sample cartridge 420, an illuminator 425, a higher magnification imaging device 450, and a second illuminator 455, among other components. In the illustrated embodiment of FIG. 4, portions of the higher magnification imaging device 450 and of the illuminator 425 are integrated into a common housing. The illuminator 425 illuminates the sample cartridge 420 from below, and second illuminator 455 illuminates that sample cartridge 420 from above. The illuminator 425 and the second illuminator 455 are controlled by a processor (e.g., 130, FIG. 1) to turn on or off at desired times to illuminate the sample cartridge 420. In embodiments, the illuminator 425 may be separate from the higher magnification imaging device 450. In embodiments, the illuminator 425 and the second illuminator 455 may be positioned and oriented differently than as shown in FIG. 4.

A positioning mechanism is shown for positioning the sample cartridge 420 below the imaging device 410 or above a camera lens assembly 454 of the higher magnification imaging device 450. As shown in FIG. 4, the imaging device 410 and the camera lens assembly 454 of the higher magnification imaging device 450 are offset from each other, such that a central axis of the imaging device 410 is offset from a central axis of the camera lens assembly 454 and/or from the higher magnification imaging device 450. In embodiments, the imaging device 410 has one objective lens and has a configured field of view, depth of field, resolving power, and magnification (e.g., 4× magnification), among other characteristics. As described in more detail below, the resolving power of the imaging device 410 may be approximately 25-micrometers or larger than 25-micrometers. As used herein, approximately 25-micrometers for the resolving power means that the resolving power may not be exactly 25-micrometers due to factors such as manufacturing imperfections and/or wear over time, among other factors.

The camera lens assembly 454 includes at least one lens and has a configured field of view, depth of field, resolving power, and magnification, among other characteristics. In embodiments, the camera lens assembly 454 provides a fixed optical magnification, such as 10×, 20×, or 40× optical magnification or another optical magnification, which enables the higher magnification imaging device 450 to function as a microscope. In embodiments, the camera lens assembly 454 provides an adjustable magnification.

The positioning mechanism includes a platform 412 and includes motors 413 which move the platform 412. In the illustrated embodiment, the imaging device 410 and the camera lens assembly 454 of the higher magnification imaging device 450 are stationary, and the positioning mechanism is capable of moving the sample cartridge 420 in two or three orthogonal directions (e.g., X and Y directions, optionally Z direction) to enable the imaging device 410 and/or the camera lens assembly 454 to capture different fields of view containing at least a portion of the sample cartridge 420. The X-and Y-directions support moving to different fields of view, and the Z-direction supports changes to the depth level at end of the working distance.

Light captured by the imaging device 410 is captured by a sensor (not shown), which may be a charge coupled device. Light captured by the camera lens assembly 454 is directed to a sensor 456 through various optical components, such as a dichroic mirror and a lens tube, among other possible optical components. The sensor 456 may be a charge coupled device that captures light to provide images. The images captured by the imaging device 410 and/or the higher magnification imaging device 450 are then conveyed to one or more processor(s) (e.g., 130, FIG. 1) for processing, as described in connection with FIG. 1.

FIG. 4 is merely an example. As described above, the higher magnification imaging device 450 and the second illuminator 455 are optional and may not be included in various embodiments. Other illustrated components are also examples, and variations are contemplated to be within the scope of the present disclosure.

With continuing reference to the example of FIG. 4, the imaging device 410 is above the sample cartridge and the higher magnification imaging device 450 is below the sample cartridge 420. In the embodiment of FIG. 4, the sample cartridge 420 has a translucent or transparent top and bottom through which the image device 410 and the higher magnification imaging device 450, respectively, may capture images of fields of view containing at least a portion of the sample cartridge 420.

FIG. 5 shows a bottom perspective view of an example of portions of a sample cartridge. The sample cartridge includes a sample chamber top portion 522 and a sample chamber bottom portion 524. The sample chamber top and bottom portions 522, 524 combine together to form a sample chamber between them, with an inlet port 526. The sample chamber top portion 522 is translucent or transparent to allow an imaging device (e.g., 410, FIG. 4) to image the sample chamber from above. The sample chamber bottom portion 524 is translucent or transparent to allow a higher magnification imaging device (e.g., 450, FIG. 4) to image the sample chamber from below. In embodiments, the top and bottom portions 522, 524 are made of glass. In embodiments, the top and bottom portions 522, 524 can be made of polymers as long as they are optically clear.

The sample cartridge may have any suitable shape and dimensions for interoperability with one or more imaging devices and/or with a point-of-care apparatus. The sample chamber formed by the top and bottom portions 522, 524 may have any suitable shape and dimensions for holding a biological sample and other materials, such as reagents and/or diluents, among other possible materials. In embodiments, the sample chamber is configured to have a sufficient depth dimension to allow constituents of an ear content sample to move in the sample chamber, e.g., float, or sink, or swim (in the case of mites). In embodiments, the sample chamber has a single depth dimension throughout the sample chamber. For example, the sample chamber may have a 200-micrometer depth dimension, with the inlet port 526 having a depth dimension of 2 millimeters. In embodiments, the sample chamber has two or more regions that have different depth dimensions. In such embodiments, the two or more regions may be formed by the sample chamber top portion 522 being molded and the sample chamber bottom portion 524 being flat.

As mentioned above, in embodiments, an entire cross-sectional area of the sample chamber corresponds to less than ten fields of view of an imaging device (e.g., 410, FIG. 4), such as one or two or four fields of view. In embodiments, an entire cross-sectional area of the sample chamber corresponds to more than one-hundred fields of view of a higher magnification imaging device (e.g., 450, FIG. 4), such as in the range of two-hundred to four-hundred fields of view, among other possibilities. In embodiments, a cross-sectional area of the sample chamber is 125 square millimeters.

Accordingly, various aspects of components of the present disclosure have been described with respect to FIGS. 1-5. As described above, aspects of the present disclosure relate to identifying larger objects in ear content samples that are 100-micrometers or larger. In aspects, the present disclosure relates to imaging larger objects in a biological sample using an imaging device having a resolving power of 25-micrometers or a resolving power of larger than 25-micrometers. A 25-micrometer resolving power is a relatively weak resolving power. For example, optical microscopes in laboratories typically have resolving powers of around 0.2 micrometers. However, as explained below using a 25-micrometer resolving power (or larger than 25-micrometer resolving power) is unexpectedly effective. In aspects, an imaging device is capable of capturing images across an entire cross-sectional area of a sample chamber within a predetermined time duration, such as in less than ten minutes, less than eight minutes, or less than five minutes.

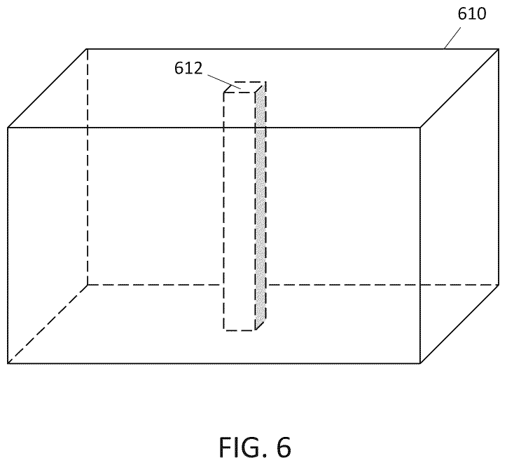

FIG. 6 shows a diagram of an example of a sample chamber 610. The shape and relative dimensions are merely illustrative, and other shapes and relative dimensions are contemplated. As mentioned above, in embodiments, an entire cross-sectional area of the sample chamber 610 corresponds to less than ten fields of view of an imaging device (e.g., 410, FIG. 4), such as one or two or four fields of view. In embodiments, an entire cross-sectional area of the sample chamber 610 corresponds to more than one-hundred fields of view of a higher magnification imaging device (e.g., 450, FIG. 4), such as in the range of two-hundred to four-hundred fields of view, among other possibilities.

In the sample chamber 610 of FIG. 6, the column 612 corresponds to a single field of view, e.g., of a high magnification image device (e.g., 450, FIG. 4). A field of view containing a portion of a sample chamber may be captured using any working distance and depth of field. As mentioned above in connection with FIG. 4, each image captures a field of view. Working distance refers to the object to lens distance where the image is at its sharpest focus, and depth of field reflects the distance between the nearest and furthest elements in a captured image that appear to be acceptably in focus. For example, if a sample chamber depth dimension is one-hundred micrometers and the working distance is within the sample chamber, then a depth of field of ten micrometers would result in some depths within the sample chamber not being in acceptable focus in the field of view. In such cases, the lens of the imaging device and/or the sample chamber 610 would need to be moved in the depth direction (e.g., Z-direction) to bring other portions of the depth within the sample chamber into acceptable focus.

An imaging device and/or a sample cartridge may move at a rate such that between fifty to one-hundred different fields of view are captured each minute. Other rates of capturing fields of view are contemplated.

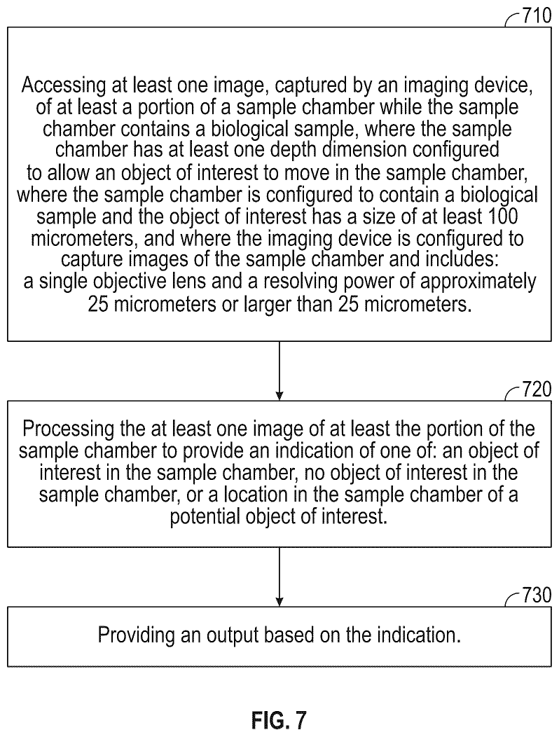

FIG. 7 is a flow diagram of an example of an operation for detecting objects in a biological sample, such as an ear content sample.

At block 710, the operation involves accessing at least one image, captured by an imaging device, of at least a portion of a sample chamber while the sample chamber contains a biological sample. The sample chamber has at least one depth dimension configured to allow an object of interest to move in the sample chamber, where the sample chamber is configured to contain a biological sample and the object of interest has a size of at least 100 micrometers. Examples and embodiments of the sample chamber was described above in connection with FIG. 4. For example, the sample chamber may have a depth dimension of 200-micrometers, and an inlet port of the sample chamber may have a depth dimension of 2 millimeters. Other dimensions are contemplated. The biological sample may be an ear content sample collected by, e.g., an ear swab. The ear content sample may include objects that are at least 100-micrometers in size, such as mites (e.g., typically 200-800 micrometers), cell clusters, or bacteria colonies, among others.

The imaging device is configured to capture images of the sample chamber and includes a single objective lens, a depth of field that is a fraction of the at least one depth dimension of the sample chamber or that is greater than the at least one depth dimension of the sample chamber, and a resolving power of approximately 25 micrometers or larger than 25 micrometers. The imaging device may be, for example, the imaging device 410 of FIG. 4. The single objective lens may provide a non-adjustable optical magnification, such as 4× magnification or another magnification. The depth of field may, for example, range from less than 200 micrometers to more than 2 millimeters. A depth of field that is less than the depth dimension of the sample chamber would result in some portions of a field of view being in focus or acceptable focus and some portions of the field of view being out of focus. Such a result is workable, for example, for imaging a constituent that forms a monolayer, such as constituents that float to the top of the sample chamber or sink to the bottom of the sample chamber, and is also workable for large constituents (e.g., 100 micrometers or larger) and for constituents that move (e.g., mites).

At block 720, the operation involves processing the at least one image of at least the portion of the sample chamber to provide an indication of one of: an object of interest in the sample chamber, no object of interest in the sample chamber, or a location in the sample chamber of a potential object of interest. As described above, trained machine learning models and/or image analytics can be applied to detect object of interest in the images, such as detecting mites, cell clusters, and/or bacteria colonies, among other objects. Specifically, the objects of interest are at least 100-micrometers in size, and the resolving power of the imaging device is 25-micrometers or larger than 25-micrometers. In the case of an object that is 100-micrometers in size, a resolving power of 25-micrometers has been found to be unexpectedly effective in providing sufficient detail for machine learning models and/or image analytics to identify such objects with an acceptable degree of accuracy. Furthermore, in some cases (e.g., detection of mites or other large constituents), it has been found that a ratio of resolving power to object size of 1:2 (e.g., 100-micrometer resolving power and 200-micrometer object) provides sufficient detail for machine learning models and/or image analytics to identify such objects with an acceptable degree of accuracy.

A benefit of weaker resolving power is that weaker resolving power corresponds to a larger field of view, which allows images of an entire cross-section of a sample chamber to be captured in a shorter amount of time. In contrast, better resolving power corresponds to a smaller field of view, which increases the amount of time needed to image an entire cross-section of a sample chamber. In embodiments, an imaging device can image all fields of view of a cross-sectional area of a sample chamber in less than a predetermined amount of time, such as in less than ten minutes, or less than eight minutes, or less than five minutes, for example. Imaging in less than a predetermined amount of time is beneficial in veterinary clinics where owners of animals expect visits to last a certain amount of time, such as thirty to sixty minutes, for example. Sample collection and analysis take time, and reviewing results and treatments with the owners also take time. Therefore, within a thirty to sixty minute visit window, imaging in less than ten minutes (or another shorter duration), is beneficial for helping veterinarians and their customers stay on schedule.

In embodiments, where the operation of block 720 does not detect any object of interest in the at least one image, the operation of block 720 may provide an indication of no object of interest in the sample chamber. The “indication” of no object of interest does not mean there is actually no object of interest in the sample chamber. Rather, the indication merely means that a determination has been made that there is no object of interest.

In embodiments, where the operation of block 720 detects an object of interest in the at least one image, the operation of block 720 may provide an indication of an object of interest in the sample chamber. The “indication” of an object of interest does not mean that there is actually an object of interest in the sample chamber. Rather, the indication merely means that a determination has been made that there is an object of interest.

In embodiments, the at least one image includes a plurality of images captured over time, and the operation of block 720 may process the images captured over time to detect objects in motion across the plurality of images. Based on detecting an object in motion (e.g., a mite), the operation of block 720 provides an indication of an object of interest (e.g., a mite) in the sample chamber. Known techniques may be used to detect an object in motion, such as optical flow techniques.

In embodiments, where the operation of block 720 detects a potential object of interest but is uncertain about the detection decision, operation of block 720 may provide an indication of the location of the potential object of interest in the sample chamber. For example, a trained machine learning model may provide a classification score for an object in an image, and the classification score may have a value that reflects uncertainty about whether the object is an object of interest. In such scenarios, the operation of block 720 can provide an indication of the location of the object in the sample chamber. The location of the object in the sample chamber can be determined based on the region of the sample chamber where the corresponding image was captured and based on a position of the object in that image.

At block 730, the operation involves providing an output based on the indication. In embodiments, the output is provided by an output device (e.g., 140, FIG. 1). For example, a display screen of a point-of-care device can display a message that a particular object was detected or not detected, e.g., a message that a mite was detected or that mites were not detected. In embodiments, the output is a text message or an email message conveying that a particular object was detected or not detected, e.g., that a mite was detected or not detected. Other types of outputs are contemplated to be within the scope of the present disclosure.

In embodiments, in case the indication is an indication of a location of a potential object of interest, the output is an electronic signal that contains the location of the potential object of interest. The electronic signal may be a signal within a processor or within a memory, for example. Subsequent to the operation of block 730, the location of the potential object of interest can be used to position the sample chamber for a higher magnification imaging device (e.g., 450, FIG. 4) to capture one or more higher magnification images of the location. The higher magnification images can be processed by machine learning models and/or image analytics to determine whether the location includes or does not include an object of interest (e.g., a mite), and the result can be conveyed to a user.

FIG. 7 is merely an example, and variations are contemplated. In embodiments, the operation may include other blocks not shown in FIG. 7. Such and other variations are contemplated to be within the scope of the present disclosure.

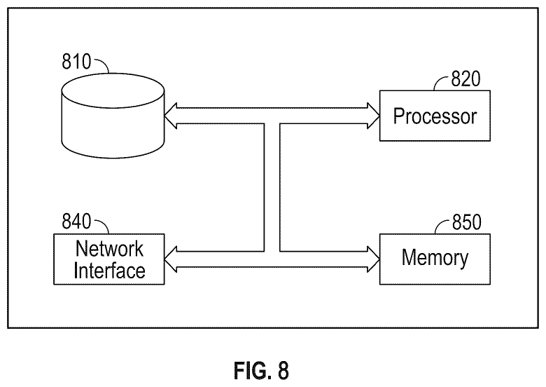

Referring now to FIG. 8, there is shown a block diagram of example components of a point-of-care apparatus at a veterinary facility. The point-of-care apparatus includes an electronic storage 810, a processor 820, a network interface 840, and a memory 850. The various components may be communicatively coupled with each other. The processor 820 may be and may include any type of processor, such as a single-core central processing unit (CPU), a multi-core CPU, a microprocessor, a digital signal processor (DSP), a System-on-Chip (SoC), or any other type of processor. The memory 850 may be a volatile type of memory, e.g., RAM, or a non-volatile type of memory, e.g., NAND flash memory. The memory 850 includes processor-readable instructions that are executable by the processor 820 to cause the apparatus to perform various operations, including those mentioned herein, such as the operations shown and described in connection with FIG. 7, and/or applying machine learning models or image analytics, among others.

The electronic storage 810 may be and include any type of electronic storage used for storing data, such as hard disk drive, solid state drive, and/or optical disc, among other types of electronic storage. The electronic storage 810 stores processor-readable instructions for causing the apparatus to perform its operations and stores data associated with such operations, such as storing data relating to computations and storing captured images, among other data. The network interface 840 may implement wireless networking technologies and/or wired networking technologies.

The components shown in FIG. 8 are merely examples, and it will be understood that a coordination system includes other components not illustrated and may include multiples of any of the illustrated components. Such and other embodiments are contemplated to be within the scope of the present disclosure.

The above-described embodiments can be expressed in the following numbered aspects:

Aspect A1. An apparatus for detecting objects in a biological sample, the apparatus comprising:
a sample chamber having at least one depth dimension configured to allow an object of interest to move in the sample chamber, the sample chamber configured to contain a biological sample, the object of interest having a size of at least 100 micrometers;
an imaging device configured to capture images of the sample chamber, the imaging device comprising a single objective lens and having a resolving power of approximately 25 micrometers or larger than 25 micrometers;
at least one processor; and
at least one memory storing instructions which, when executed by the at least one processor, cause the apparatus at least to perform, without human intervention: accessing at least one image, captured by the imaging device, of at least a portion of the sample chamber while the sample chamber contains the biological sample;
processing the at least one image of at least the portion of the sample chamber to provide an indication of one of: an object of interest in the sample chamber, no object of interest in the sample chamber, or a location in the sample chamber of a potential object of interest; and providing an output based on the indication.

Aspect A2. The apparatus of Aspect A1, wherein:
the imaging device comprises a field of view corresponding to the resolving power,
a cross-sectional area of the sample chamber is equivalent to a plurality of the field of view, and
the imaging device is capable of capturing images across an entirety of the cross-sectional area of the sample chamber within a predetermined time duration of less than ten minutes.

Aspect A3. The apparatus of Aspect A1 or Aspect A2, wherein the at least one image comprises a plurality of images captured over time,
wherein in the processing the at least one image, the instructions, when executed by the at least one processor, cause the apparatus at least to perform:
   detecting an object in motion across the plurality of images captured over time; and
   providing, based on the objection in motion, the indication of the object of interest in the sample chamber.

Aspect A4. The apparatus of any one of the preceding Aspects, further comprising a higher magnification imaging device configured to capture an image of a portion of the sample chamber at a higher magnification than the imaging device.

Aspect A5. The apparatus of Aspect A4, wherein the instructions, when executed by the at least one processor, further cause the apparatus at least to perform:
capturing, by the higher magnification imaging device, based on the indication of the location in the sample chamber of the potential object of interest, at least one higher magnification image of the location in the sample chamber; and
processing the at least one higher magnification image of the location in the sample chamber to perform object detection to indicate one of: presence of the object of interest at the location in the sample chamber, or absence of the object of interest at the location in the sample chamber.

Aspect A6. The apparatus of Aspect A4 or Aspect A5, wherein a central axis of the imaging device is offset from a central axis of the higher magnification imaging device.

Aspect A7. The apparatus of any one of Aspect A4 to Aspect A6, wherein the imaging device is positioned on a first side of the sample chamber and the higher magnification imaging device is positioned on a second side of the sample chamber,
wherein the first side and the second side are opposite sides of the sample chamber.

Aspect A8. A method for detecting objects in a biological sample, the method comprising, without human intervention:
accessing at least one image, captured by an imaging device, of at least a portion of a sample chamber while the sample chamber contains a biological sample, wherein:
   the sample chamber has at least one depth dimension configured to allow an object of interest to move in the sample chamber, the object of interest having a size of at least 100 micrometers, and the imaging device is configured to capture images of the sample chamber, the imaging device comprising a single objective lens and having a resolving power of approximately 25 micrometers or larger than 25 micrometers;
processing the at least one image of at least the portion of the sample chamber to provide an indication of one of: an object of interest in the sample chamber, no object of interest in the sample chamber, or a location in the sample chamber of a potential object of interest; and
providing an output based on the indication.

Aspect A9. The method of Aspect A8, wherein:
the imaging device comprises a field of view corresponding to the resolving power,
a cross-sectional area of the sample chamber is equivalent to a plurality of the field of view, and
the imaging device is capable of capturing images across an entirety of the cross-sectional area of the sample chamber within a predetermined time duration of less than ten minutes.

Aspect A10. The method of Aspect A8 or Aspect A9, wherein the at least one image comprises a plurality of images captured over time,
wherein the processing the at least one image comprises:
   detecting an object in motion across the plurality of images captured over time; and
   providing, based on the objection in motion, the indication of the object of interest in the sample chamber.

Aspect A11. The method of any one of Aspect A8 to Aspect A10, further comprising:
capturing, by a higher magnification imaging device, based on the indication of the location in the sample chamber of the potential object of interest, at least one higher magnification image of the location in the sample chamber, the higher magnification imaging device having a higher magnification than the imaging device; and
processing the at least one higher magnification image of the location in the sample chamber to perform object detection to indicate one of: presence of the object of interest at the location in the sample chamber, or absence of the object of interest at the location in the sample chamber.

Aspect A12. The method of Aspect A11, wherein a central axis of the imaging device is offset from a central axis of the higher magnification imaging device.

Aspect A13. The method of Aspect All or Aspect A12, wherein the imaging device is positioned on a first side of the sample chamber and the higher magnification imaging device is positioned on a second side of the sample chamber,
wherein the first side and the second side are opposite sides of the sample chamber.

Aspect A14. A processor-readable medium storing instructions which, when executed by at least one processor of an apparatus, causes the apparatus at least to perform, without human intervention:
accessing at least one image, captured by an imaging device, of at least a portion of a sample chamber while the sample chamber contains a biological sample, wherein:
   the sample chamber has at least one depth dimension configured to allow an object of interest to move in the sample chamber, the object of interest having a size of at least 100 micrometers, and
   the imaging device is configured to capture images of the sample chamber, the imaging device comprising a single objective lens and having a resolving power of approximately 25 micrometers or larger than 25 micrometers;
processing the at least one image of at least the portion of the sample chamber to provide an indication of one of: an object of interest in the sample chamber, no object of interest in the sample chamber, or a location in the sample chamber of a potential object of interest; and
providing an output based on the indication.

Aspect A15. The processor-readable medium of Aspect A14, wherein:
the imaging device comprises a field of view corresponding to the resolving power, a cross-sectional area of the sample chamber is equivalent to a plurality of the field of view, and
the imaging device is capable of capturing images across an entirety of the cross-sectional area of the sample chamber within a predetermined time duration of less than ten minutes.

Aspect A16. The processor-readable medium of Aspect A14 or Aspect A15, wherein the at least one image comprises a plurality of images captured over time,
wherein in the processing the at least one image, the instructions, when executed by the at least one processor, cause the apparatus at least to perform:
   detecting an object in motion across the plurality of images captured over time; and
   providing, based on the objection in motion, the indication of the object of interest in the sample chamber.

Aspect A17. The processor-readable medium of any one of Aspect A14 to Aspect A16, wherein the apparatus comprises a higher magnification imaging device configured to capture an image of a portion of the sample chamber at a higher magnification than the imaging device.

Aspect A18. The processor-readable medium of Aspect A17, wherein the instructions, when executed by the at least one processor, further cause the apparatus at least to perform:
capturing, by the higher magnification imaging device, based on the indication of the location in the sample chamber of the potential object of interest, at least one higher magnification image of the location in the sample chamber; and
processing the at least one higher magnification image of the location in the sample chamber to perform object detection to indicate one of: presence of the object of interest at the location in the sample chamber, or absence of the object of interest at the location in the sample chamber.

Aspect A19. The processor-readable medium of Aspect A17 or Aspect A18, wherein a central axis of the imaging device is offset from a central axis of the higher magnification imaging device.

Aspect A20. The processor-readable medium of any one of Aspect A17 to Aspect A19, wherein the imaging device is positioned on a first side of the sample chamber and the higher magnification imaging device is positioned on a second side of the sample chamber,
wherein the first side and the second side are opposite sides of the sample chamber.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors (and/or the systems, devices, and/or servers they operate in) to perform one or more methods, operations, and/or algorithms.

Any of the herein described methods, operations, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. An apparatus for detecting objects in a biological sample, the apparatus comprising:
a sample chamber having at least one depth dimension configured to allow an object of interest to move in the sample chamber, the sample chamber configured to contain a biological sample, the object of interest having a size of at least 100 micrometers;
an imaging device configured to capture images of the sample chamber, the imaging device comprising a single objective lens and having a resolving power of approximately 25 micrometers or larger than 25 micrometers;
at least one processor; and
at least one memory storing instructions which, when executed by the at least one processor, cause the apparatus at least to perform, without human intervention:
accessing at least one image, captured by the imaging device, of at least a portion of the sample chamber while the sample chamber contains the biological sample;
processing the at least one image of at least the portion of the sample chamber to provide an indication of one of: an object of interest in the sample chamber, no object of interest in the sample chamber, or a location in the sample chamber of a potential object of interest; and
providing an output based on the indication.

2. The apparatus of claim 1, wherein:
the imaging device comprises a field of view corresponding to the resolving power,
a cross-sectional area of the sample chamber is equivalent to a plurality of the field of view, and
the imaging device is capable of capturing images across an entirety of the cross-sectional area of the sample chamber within a predetermined time duration of less than ten minutes.

3. The apparatus of claim 1, wherein the at least one image comprises a plurality of images captured over time,
wherein in the processing the at least one image, the instructions, when executed by the at least one processor, cause the apparatus at least to perform:
detecting an object in motion across the plurality of images captured over time; and
providing, based on the objection in motion, the indication of the object of interest in the sample chamber.

4. The apparatus of claim 1, further comprising a higher magnification imaging device configured to capture an image of a portion of the sample chamber at a higher magnification than the imaging device.

5. The apparatus of claim 4, wherein the instructions, when executed by the at least one processor, further cause the apparatus at least to perform:
capturing, by the higher magnification imaging device, based on the indication of the location in the sample chamber of the potential object of interest, at least one higher magnification image of the location in the sample chamber; and
processing the at least one higher magnification image of the location in the sample chamber to perform object detection to indicate one of: presence of the object of interest at the location in the sample chamber, or absence of the object of interest at the location in the sample chamber.

6. The apparatus of claim 4, wherein a central axis of the imaging device is offset from a central axis of the higher magnification imaging device.

7. The apparatus of claim 4, wherein the imaging device is positioned on a first side of the sample chamber and the higher magnification imaging device is positioned on a second side of the sample chamber,
wherein the first side and the second side are opposite sides of the sample chamber.

8. A method for detecting objects in a biological sample, the method comprising, without human intervention:
accessing at least one image, captured by an imaging device, of at least a portion of a sample chamber while the sample chamber contains a biological sample, wherein:
the sample chamber has at least one depth dimension configured to allow an object of interest to move in the sample chamber, the object of interest having a size of at least 100 micrometers, and
the imaging device is configured to capture images of the sample chamber, the imaging device comprising a single objective lens and having a resolving power of approximately 25 micrometers or larger than 25 micrometers;
processing the at least one image of at least the portion of the sample chamber to provide an indication of one of: an object of interest in the sample chamber, no object of interest in the sample chamber, or a location in the sample chamber of a potential object of interest; and
providing an output based on the indication.

9. The method of claim 8, wherein:
the imaging device comprises a field of view corresponding to the resolving power,
a cross-sectional area of the sample chamber is equivalent to a plurality of the field of view, and
the imaging device is capable of capturing images across an entirety of the cross-sectional area of the sample chamber within a predetermined time duration of less than ten minutes.

10. The method of claim 8, wherein the at least one image comprises a plurality of images captured over time,
wherein the processing the at least one image comprises:
detecting an object in motion across the plurality of images captured over time; and
providing, based on the objection in motion, the indication of the object of interest in the sample chamber.

11. The method of claim 8, further comprising:
capturing, by a higher magnification imaging device, based on the indication of the location in the sample chamber of the potential object of interest, at least one higher magnification image of the location in the sample chamber, the higher magnification imaging device having a higher magnification than the imaging device; and
processing the at least one higher magnification image of the location in the sample chamber to perform object detection to indicate one of: presence of the object of interest at the location in the sample chamber, or absence of the object of interest at the location in the sample chamber.

12. The method of claim 11, wherein a central axis of the imaging device is offset from a central axis of the higher magnification imaging device.

13. The method of claim 11, wherein the imaging device is positioned on a first side of the sample chamber and the higher magnification imaging device is positioned on a second side of the sample chamber,
wherein the first side and the second side are opposite sides of the sample chamber.

14. A processor-readable medium storing instructions which, when executed by at least one processor of an apparatus, causes the apparatus at least to perform, without human intervention:
accessing at least one image, captured by an imaging device, of at least a portion of a sample chamber while the sample chamber contains a biological sample, wherein:
the sample chamber has at least one depth dimension configured to allow an object of interest to move in the sample chamber, the object of interest having a size of at least 100 micrometers, and
the imaging device is configured to capture images of the sample chamber, the imaging device comprising a single objective lens and having a resolving power of approximately 25 micrometers or larger than 25 micrometers;
processing the at least one image of at least the portion of the sample chamber to provide an indication of one of: an object of interest in the sample chamber, no object of interest in the sample chamber, or a location in the sample chamber of a potential object of interest; and
providing an output based on the indication.

15. The processor-readable medium of claim 14, wherein:
the imaging device comprises a field of view corresponding to the resolving power,
a cross-sectional area of the sample chamber is equivalent to a plurality of the field of view, and
the imaging device is capable of capturing images across an entirety of the cross-sectional area of the sample chamber within a predetermined time duration of less than ten minutes.

16. The processor-readable medium of claim 14, wherein the at least one image comprises a plurality of images captured over time,
wherein in the processing the at least one image, the instructions, when executed by the at least one processor, cause the apparatus at least to perform:
detecting an object in motion across the plurality of images captured over time; and
providing, based on the objection in motion, the indication of the object of interest in the sample chamber.

17. The processor-readable medium of claim 14, wherein the apparatus comprises a higher magnification imaging device configured to capture an image of a portion of the sample chamber at a higher magnification than the imaging device.

18. The processor-readable medium of claim 17, wherein the instructions, when executed by the at least one processor, further cause the apparatus at least to perform:
capturing, by the higher magnification imaging device, based on the indication of the location in the sample chamber of the potential object of interest, at least one higher magnification image of the location in the sample chamber; and
processing the at least one higher magnification image of the location in the sample chamber to perform object detection to indicate one of: presence of the object of interest at the location in the sample chamber, or absence of the object of interest at the location in the sample chamber.

19. The processor-readable medium of claim 17, wherein a central axis of the imaging device is offset from a central axis of the higher magnification imaging device.

20. The processor-readable medium of claim 17, wherein the imaging device is positioned on a first side of the sample chamber and the higher magnification imaging device is positioned on a second side of the sample chamber,
wherein the first side and the second side are opposite sides of the sample chamber.
